(19) United States
(12) Patent Application Publication
(10) Pub. No.: US 2005/0228738 A1
(43) Pub. Date: Oct. 13, 2005

(54) Base line futures contract (BLC)

(76) Inventor: William R. Harris, Greenwich, CT (US)

Correspondence Address: Susan Harris, 1 Lita Dr., Greenwich, CT, 06830, US

(21) Appl. No.: 10/819,793

(22) Filed: Apr. 8, 2004

(51) Int. Cl. G06F 17/60

(52) U.S. Cl. 705/37

(57) ABSTRACT

The invention titled the “Base Line Futures Contract”, (BLC) is a method of doing business enabling the trading of Futures Contracts for non-fungible properties. Unlike the traditional Futures Contract that trades specific fungible property and typically calls for physical delivery, the invention instead trades only the referent property's change in value. Through the use of an algorithm the invention establishes a “Base Line” price from which price movements are calculated. The algorithm determines the contract's opening price and contracts not otherwise settled at expiration of the contract cash settle at a price determined by the algorithm. The invention is intended to be traded on a public Futures Exchange and gives companies whose assets are non-fungible and speculators a tool with which to capture price movements as well as a way to hedge against a non-fungible asset's change in value.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE OR COMPUTER PROGRAM LISTING COMPACT DISK APPENDIX

Not Applicable

### BACKGROUND OF THE INVENTION

I. Field of Invention

Applicant's invention is a new business method using a new Futures Contract for property rights that are non-fungible and in effect non-commoditizable. The invention, titled the “Base Line Futures Contract” (BLC), is closely related to the Commodities Futures Contracts (CFC) which are traded on the various exchanges located around the world. The BLC is constructed to trade as a Futures Contract meeting standardized quantity, quality, and delivery terms inherent in every Futures Contract. Because the BLC is tradable, it provides a means to realize or “capture” appreciation or hedge against the decrease in value of the referent property.

Unlike today's Futures Contract that shadows the actual spot price of the underlying commodity, the BLC instead reflects the perceived change in value of the referent property. By using the invention of the BLC, Owners, Investors, Financiers, Insurance Companies, and the like for the first time will be better able to finance and/ or protect against their properties' fluctuation in value. In short, the Base Line Contract is a financial tool enabling an interested party to “capture” price appreciation or alternatively to hedge against price declines. The invention of the BLC creates a new financial tool for risk management of properties, which share common characteristics but are not fungible.

By way of example only, a BLC for “Class A Midtown New York City office space” allows the owner of a N.Y.C. office building to hedge against possible decline in lease rates for such space. Plainly, all Real Estate is unique and thus non-fungible, and the office-building owner does not wish or intend to sell his building. He may, nevertheless, using a BLC protect against a possible decline in lease rates.

Another example is a professional Sports Franchise of which the principle assets are its contracts with its players. Obviously, the individual player (the franchise's asset) is unique. However, the market value of a player can be measured by way of his statistical performance, and that value can be traded. That is to say, as a function of a player's statistics, his market value can be determined and using a BLC the player's market value can be traded: allowing a Franchise to “hedge” against possible later under-performance or alternatively to realize and capture value in an asset (the player's contract) that is performing better than his prior expected statistical performance would predict. For instance, if the player under-performs, then the Franchise suffers a loss from this asset's expected output. On the other hand, if the player performs better than his expected statistical output, the Franchise has realized an added value in this asset (i.e. the Franchise's assumed cost for its contract with the player is below his market value based on recent performance).

To further illustrate these concepts, the recent World Series (2003) which matched the Florida Marlins against the New York Yankees showed that as an economic matter, the Yankees had either grossly over paid for their players or the Marlins had made very good (“cheap”) player purchases. (Or, of course, both situations might be true to some lesser extent.) Because the Yankee's annual payroll was $182-million while the Marlins' was just under $48-million. Yet the Marlins won!

How might the Yankees have protected themselves (“hedged”) against the possible economic loss in value of their player contracts? Answer: having sold short during the season or prior to the Series BLC contracts on such players. They would not thereby have won the Series, but the profits on the short sales would have somewhat offset the loss in value of their player contracts.

Conversely, how could the Marlins as an economic matter realize the plain appreciation in value of their Player contracts without dismembering the team? Had they previously bought BLC contracts on their players, they would assuredly now be able to sell those BLC contracts at handsome profits and still keep their players.

Recently, the General Manager of the Milwaukee Brewers commented that “you have to sell a lot of tickets to support a $10-million player”. Mr. Melvin's comments were made in respect to the Brewers' having to release several of its key players prior to the 2004 season due to the franchise's poor gate receipts.

With the invention of the BLC, franchises such as the Brewers, would have a meaningful tool with which to hedge against a team's ticket sales. For example, if a franchise bought its players BLC contracts and the players statistical output was better than the general market's expectations, the contracts would increase in value helping to offset the team's poor attendance revenue. On the other hand, if the franchise's players were performing poorly and below the market's expectations, the franchise could just as easily sell BLC contracts on its players, which in turn would increase in value as the contracts' prices declined. Either way (or in combination: both buying and selling contracts on different players), the BLC provides a professional franchise with an additional tool with which to help protect its revenue stream, without having to dismantle its team.

II. Description of Related Art

Years ago commodity trading largely resembled a Middle Eastern bazaar. Merchants offering their commodities for sale brought samples to the Exchange. Buyers would come to the Exchange to examine the quality of the offered merchandise and bid for it. Businessmen vied with other buyers or sellers, each trying to obtain the best price for their products or to buy at the most competitive price. Early in the 19^{th} century, American businessmen began setting up organized markets with uniform standards and procedures to make the buying and selling of commodities easier. These central marketplaces provided a place for buyers and sellers—such as farmers and grain dealers—to meet, set quality and quantity standards, and establish rules of trade. From the mid-to-late 19^{th} century, about 1,600 Exchanges sprang up across the United States, mostly at major railheads, inland water ports and seaports.

Originally, all transactions were “spot” sales: where payment and delivery were concurrent with agreement on the price and other terms. Gradually, however, same producers began to sell their crops well prior to harvest. (For instance, in the Spring: “. . . all wheat from my North Field at Harvest.”) This is commonly referred to as a “Forward Contract”. The next step was to CFCs as we know them today with terms as to price, quantity, quality, maturity and delivery agreed upon and traded through an organized Exchange.

As communications and transportation became more efficient in the early 20^{th} century, as centralized warehouses were built in principal market centers (such as New York and Chicago) that could be used to distribute goods more economically and, as business expanded to become more national than regional, there was not a need any longer for so many local Exchanges. The Exchanges in the smaller cities began to disappear, while the competition in larger markets led to the consolidation of many big-city Exchanges. Of the more than one thousand Commodity Exchanges that existed in the United States about 100 years ago, only nine principal Exchanges exist today. They include the following: Chicago Board Options Exchange (CBOE), Chicago Board of Trade (CBT), Chicago Mercantile Exchange (CME), Comex Division of the New York Mercantile Exchange (CMX), Coffee Sugar and Cocoa Exchange, Division of New York Cotton Exchange (CSCE), New York Cotton Exchange, Division of New York Board of Trade (CTN), Kansas City Board of Trade (KC), New York Mercantile Exchange (NYM), and the New York Futures Exchange (NYFE).

The oldest organized Exchange in the United States is the Chicago Board of Trade (CBOT). The CBOT was established in 1848 and grew with the westward expansion of American ranching and agriculture. Today, the CBOT is the largest, most active Futures Exchanges in the world. Other early American Future Exchanges include the Mid American Commodity Exchange founded in 1868, New York Cotton Exchange 1870, New York Mercantile Exchange 1872, Chicago Mercantile Exchange 1874, New York Coffee Exchange 1882, and the Kansas City Board of Trade in 1882.

More than 400 million Futures Contracts are exchanged on the U.S. Exchange floors each year, trading such commodities as the following: Crude Oil, Heating Oil, Gasoline, Natural Gas, Propane, Platinum, Palladium, Gold, Silver, Copper, Orange Juice, Wheat, Corn, Soybeans, Cattle, Hogs, Pork Bellies, Cocoa, Coffee, Sugar, Currencies, Libor U.S. Treasury Bonds and T-Bills.

Today, physical supplies of the traded commodities are nowhere to be found on the trading floors of the various operating Exchanges. In fact, they are infrequently delivered through the Exchanges at all, even though Exchange Rules permit physical delivery. Instead, traders buy and sell on the Exchanges through Instruments called Futures Contracts, and only a few such contracts are ever settled at expiration by delivery of the underlying commodity. A Futures Contract is a legally binding obligation for the holder of the contract to buy or sell a particular commodity at a specific price and location at a specific date in the future. The contracts are standardized; that means that everyone trades contracts with the same specifications for quality, quantity, and delivery terms. For example, Crude Oil, which is traded on the New York Mercantile Exchange in New York City and which is the world's most actively traded Petroleum Commodity, has as its delivery point Cushing, Okla. Each Future Contract represents 1,000 barrels of Crude Oil, and the quality of the oil is “Light Sweet Crude” mainly, “West Texas Intermediate”. That way, if the price of Crude Oil is quoted on the Exchange at $30.23 a barrel, everyone knows that's the wholesale price for delivery of a specific grade and quality of Crude Oil at Cushing, Okla. No one can say later that he thought it was the price for Louisiana Sweet Crude at St. James, La.

For more than 100 years American Futures Exchanges devoted their activities exclusively to Commodity Futures. However, in the 1970's Financial Futures were introduced making a substantial change in the type of fungible properties that could be traded across the Exchange. Unlike Commodity Futures, which call for delivery of a physical commodity, Financial Futures require delivery of a Financial Instrument. The first Financial Futures were Foreign Currency Contracts introduced in 1972 at the International Monetary Market (IMM), a division of the Chicago Mercantile Exchange (CME). Next came Interest Rate Futures, introduced at the Chicago Board of Trade in 1975. An Interest Rate Futures Contract specifies delivery of a Fixed-Income Security. For example, an Interest Rate Futures Contract may specify a U.S. Treasury Bill, Note, or Bond as the underlying instrument. Finally, Stock Index Futures were introduced in 1982 at the Kansas City Board of Trade, the Chicago Mercantile Exchange, and the New York Futures Exchange. A Stock Index Futures Contract specifies a particular Stock Market Index as its underlying instrument.

Financial Futures have been so successful that they now constitute the bulk of all Futures trading. This success is largely attributed to the fact that Financial Futures have become an indispensable tool for “financial risk management” by corporations and portfolio managers.

Futures Contracts are widely used for hedging. Hedging allows someone to offset the risk of a fluctuating future price for supplies of a commodity. For example, a Copper Mining Company might sell a Futures Contract to lock in its sales price and protect its revenue should the market price of Copper fall. (If Copper prices rise instead, then the increase in value of the physical metal offsets its loss on the Futures Contract.) At the same time, a Wire Manufacturer who buys Copper to use as a raw material in the production of wire might buy a Copper Futures Contract to lock in its raw materials cost. (If the price of Copper falls, the cost advantage gained by buying the actual Copper at a lower price offsets its loss on the futures market.)

In both cases, the Copper Mining Company and the Wire Manufacturer could, if they wished, hold their Futures Contracts until they expired, and then make or take delivery through the Exchange at a warehouse designated as an Exchange delivery location. As noted previously, this procedure is rarely effected. Almost all Futures Contracts are closed out by offsetting purchase or sale prior to expiration, known in Futures jargon as a “reverse trade”.

A Futures position can be closed out at any time; you do not have to hold the Contract to maturity. An offsetting or “reverse trade” works like this: suppose you are currently short five Treasury Bond Contracts, and you instruct your Broker to close out the position. Your Broker responds by going long five Treasury Bond Contracts for your account. In this case going long five Contracts is a “reverse trade” because it cancels exactly your previous five-contract short position. At the end of the day of your “reverse trade”, your account will be marked to market at the Futures price realized by the “reverse trade”. From then on, your position is closed out and no more gains or losses will be realized.

This example illustrates that closing out a Futures position is no more difficult than initially entering into a position. There are two basic reasons to close out a Futures position before Contract maturity. The first: to capture a current gain or loss, without realizing future price risk. The second: to avoid the delivery requirements that come from holding a Futures Contract until it matures. In fact, over 98 percent of all Futures Contracts are closed out before Contract maturity, which indicates that less than 2 percent of all Futures Contracts result in delivery of the underlying Commodity or Financial Instrument.

Speculators also play an important role in the market by adding liquidity. Certainly hedging is the major economic purpose for the existence of Futures Markets. However, a viable Futures Market cannot exist without participation by both Hedgers and Speculators. Hedgers transfer price risk to Speculators, and Speculators absorb price risk. Hedging and Speculating are complementary activities. Suppose you are thinking about speculating on Commodity Prices because you believe you can accurately forecast Future Prices most of the time. The most convenient way to speculate is with Futures Contracts. If you believe that the price of Gold will go up, then you can speculate on this belief by buying Gold Futures. Alternatively, if you think Gold will fall in price, you can speculate by selling Gold Futures. To be more precise, you think that the current Futures price is either too high or too low relative to what Gold prices will be in the future.

Buying Futures is referred to as “going long”, or establishing a “long” position. Selling Futures is called “going short”, or establishing a “short” position. A Speculator accepts price risk in order to bet on the direction of prices by going long or short. To illustrate the basics of speculating, suppose you believe the price of Gold will go up. In particular, the current Future price for delivery in three months is $400 per ounce. You think that Gold will be selling for more than that three months from now, so you go long 100, Three-Month Gold Contracts. Each Gold Contract represents 100 Troy ounces, so 100 Contracts represent 10,000 ounces of Gold with a total Contract value of 10,000×$400=$4,000,000. This is a $4-million long Gold position. Now suppose your belief turns out to be correct and at Contract maturity the market price of Gold is $420 per ounce. From your long Futures position, you accept delivery of 10,000 Troy ounces of Gold at $400 per ounce and immediately sell the Gold at the market price of $420 per ounce. Your profit is $20 per ounce or 10,000×$20=$200,000, less applicable commissions. Of course, if your belief turned out wrong and Gold fell in price, you would lose money since you must still buy the 10,000 Troy ounces at $400 per ounce to cover your Futures Contract obligations. Thus, if Gold fell to say, $390 per ounce, you would lose $10 per ounce or 10,000×$10=$100,000. As this example suggests, Futures Speculation is risky, but it is potentially rewarding if you can accurately forecast the direction of future Commodity price movements.

As stated above, most Hedgers and Speculators, no matter what the commodity, close out their futures positions by offsetting their purchases or sells before their Futures Contracts expire, thus not making or taking physical delivery of the commodity. Knowing, however, that the “Purchaser” or “Seller” of the Futures Contract may demand delivery of the physical commodity at the contract price, helps to keep the market price true to life.

Prices of the traded commodities are determined in an open and continuous auction conducted either electronically, through a computer network, matching buyers and sellers, or on the Exchange floors, a process called “Open Outcry”. By Exchange rules and by laws, no one can bid under a higher bid and no one can offer to sell higher than someone else's lower offer. This rule helps to keep the markets as efficient as possible.

Market direction is determined by supply and demand: if buyers are more eager to buy than sellers are to sell, then prices will tend to rise. If the opposite is true, prices will tend to fall. For example, suppose you are selling your Stamp Collection. You put an ad in the newspaper and wait for the customers to respond. If a lot of people are interested in your collection, you will probably be able to get a good price. But, if very few contact you, or if a hundred other people are selling a similar stamp collection at the same time and only a few collectors are interested in buying, chances are you will have to cut your price to be competitive with the other sellers and to attract interest from buyers. The futures markets work the same way.

Another type of Futures Contract is the Futures Index Contract. The Futures Index Contract is either an Arithmetic or Weighted Average of a selected list of Futures Contracts or Securities that serve to value a particular market segment as a whole. For example, the Standard & Poor's 500 Stock Index Futures Contract, which trades on the Chicago Mercantile Exchange, is a weighted average of the 500 largest publicly traded American stock held companies. This contract, like other Futures Index Contracts, allows the contract holder to hedge or speculate in the overall market instead of having to buy or sell a specific commodities contract or share of a company's stock. Future Index Contracts are common and their prices are calculated from data as to the prices of actually completed market transactions of the constituent securities or commodities, as the case may be.

Today, because business in one part of the world is so closely linked to markets in other parts of the world and because the commodities traded are used world-wide, Exchange markets are virtually open 24-hours per day, through computer networks.

For many Commodities that are not traded on an Exchange the basic principles of hedging still exist because these commodities in many cases are similar to commodities that are traded. For example, Jet Fuel (which is not traded on any Exchange) and Heating Oil (which is traded on the New York Mercantile Exchange) are similar in quality and are often priced within a few cents of each other. So many Airlines, which have to buy Jet Fuel, have found that they can satisfactorily hedge by using the Heating Oil Futures Contract.

One of the main functions of the Futures Exchange is to guarantee each trade, ultimately acting as the seller to every buyer and the buyer to every seller. Market participants must post good-faith deposits called margin. This is necessary because the Exchange must know that participants have sufficient funds to handle losses that they may experience in the market. As soon as anyone buys or sells a Futures Contract, such person must deposit an amount of money that the Exchange determines is sufficient to cover any one-day price move. As long as that person or firm holds on to the contract, the Exchange must see that minimum margin funds for that position are maintained with the contract holder depositing additional funds whenever the market moves against him.

The Exchange does not take positions in the market, nor does it advise people on what positions to take. Instead, it has the responsibility to ensure that the market is fair and orderly. It does this by setting and enforcing rules regarding margin deposits, trading and delivery procedures, participant's qualifications and other aspects of trading. Participants who violate the rules can be subject to fines or other sanctions.

There are a number of Commodity Exchanges throughout the world, where people participate in a public auction, buying and selling commodities they do not see, with other people whose identities are anonymous. In order for an Exchange to function, the commodities traded must meet strict specifications for quality, quantity and delivery terms. Additionally, with the Exchanges assuring that each purchase and sale is “guaranteed” the futures markets not only work but are so effective that the quotations derived from these transactions are used as pricing standards by companies and individuals around the globe for “spot” transactions. In short, the Futures Contracts traded on the Exchanges throughout the world enable thousands of merchants—from Investment Banking Firms which sell financial products to oil companies to farmers who feed the world—to operate more efficiently, making the Futures Contract and the Exchange mechanism a vital foundation for today's global economy.

The Futures Contract has no doubt played a major role in shaping today's global economy, allowing businesses to operate more efficiently. However, the contract has remained stagnant since its origination, limiting its use to only those property rights that are fungible and which can be sold for cash at a market-determined price.

Futures Contracts for Agricultural Commodities like Wheat, Corn, Hogs, Cattle, Coffee and Orange Juice do not call for delivery of identified and segregated goods (the Wheat in a particular farmer's silo, etc.); rather, any goods meeting the specifications set forth in the contract (e.g., “Winter Wheat”) may be delivered in satisfaction of the contract, because all such Wheat is fungible: interchangeable, substitutable. The same can be said for Metals and Energy: Gold, Silver, Copper, Crude Oil, Heating Oil and Natural Gas.

The Market price for Commodity Futures Contracts cannot far depart from current “spot” commodity prices plus the “carrying cost” (warehousing and interest, etc.) for such commodities. This imposes a certain discipline on the market. Again, as expiration of a Commodities Futures Contract approaches its price will move toward the “Spot” price. At expiration, the party owing delivery must in many cases buy “spot physical” in order to satisfy his obligation to deliver the commodity promised for via the Futures Contract price. Simply stated, in a Commodity Futures Contract the price directly reflects the actual market price of the commodity being traded.

The only significant change to the Commodity Futures Contract since its origination has been the introduction of Financial Futures (in the 1970's) and the inclusion of Cash Settlement. Cash Settlement simply means that the buyer and seller settle up in cash with no actual delivery to take place. For example, the S&P Futures Contract cash settles. With this Contract, actual delivery would be very difficult because the seller of the contract would have to buy all 500 Stocks in exactly the right proportions to effect delivery. Clearly this is not practical, so this Contract incorporates cash settlement. To further illustrate, suppose you bought an S&P Contract at a futures price of 1,300. The Contract size is $250 times the difference between the Futures price of 1,300 and the level of the S&P 500 Index at Contract maturity. For example, suppose that at maturity the S&P had actually fallen to 1,270. In this case, the buyer of the Contract must pay $250×(1,300−1,270)=$7,500 to the seller of the Contract. In effect, the buyer of the Contract has agreed to 250 units of the Index at a price of $1,300 per unit. If the Index is below 1,300, the buyer will lose money. If the Index is above that, then the seller will lose money.

Other examples of CFCs that cash settle are the NASDAQ 100 Index and the Goldman Sachs Commodity Index, as to both of which the referent property is not delivered in satisfaction of the Contract. Again, the reason cash is acceptable in lieu of delivery of the referent property is that the Indices are accurate: that is to say, at any particular point in time the contract reflects the actual market price of the individual referent properties which make up the Index. (It should be noted, however, that the Index is made up of fungible properties, and had the Contract been designed to deliver the referent properties, even though impractical, it would have at all times been possible.)

Not all Financial Futures are settled for in cash. For instance, delivery is often accomplished by a transfer of registered ownership. For example, ownership of U.S. Treasury Bill, Note and Bond issues are registered at the Federal Reserve in computerized book-entry form. Futures delivery is accomplished by a notification to the Fed to effect a change of registered ownership.

Whether there will be physical delivery or cash settlement, the underlying property of a Financial Futures Contract (unlike the BLC) is fully fungible: tradable share of Stocks, Bonds, Currencies and Commodity Indexes are all actively traded on public Exchanges. This is radically different from the BLC: there, the underlying or referent property is non-fungible and not publicly traded.

Of course, there are many assets used in business or as investments that are not fungible and whose owners do not wish to sell them. By way of an example previously noted, the office space in a mid-town New York City office building, even if it is classified by knowledgeable realty brokers as “Class A” space, is still individually unique. It may be in a “trophy” office building, like the recently sold GM Building. But in any event, by definition, all real estate is unique and thus non-fungible.

Again, the building owner may not wish to sell his building or any part of it, but may still nonetheless want to protect against a severe decline in lease rates. Were the building fungible and deliverable, like the subject matter of the other Futures Contracts, the building owner could engage in something like hedging (selling short against his position) as a risk management tool. But it is neither fungible nor deliverable.

The BLC allows the owners of such unique and non-deliverable property to “commoditize” what has theretofore been “non-commoditizable” so that precisely such risk management can be conducted. The BLC does that by trading only changes in perceived value from an established “Base Line”, not the referent property of the BLC itself. Unlike a Commodities Futures Contract, there will be no settlement at expiration by delivery of barrels of West Texas Intermediate Crude Oil at Cushing, Okla. or bushels of Winter Wheat at Chicago. Instead, the change in perceived value of the referent property, as calculated by an agreed algorithm will be determined, and that difference since the date when the BLC was either purchased or sold will be paid or received, as the case may be, in cash.

### BRIEF SUMMARY OF THE INVENTION

The invention of the BLC allows industries whose assets are non-fungible to trade their properties' change in value. Moreover, the new contract will enable companies to participate and take advantage of the financial risk management tools that the present-day Futures Contract offers. The Futures Contract has been in existence for over one hundred years; however, it was created specifically for producers and users of Commodities. The CFC has aided Farmers, Miners, Oil Companies and the like to gain financing and to protect their businesses from undue market risk.

In the 1970s, the Futures Exchanges began to trade Financial Futures, which require delivery of a Financial Instrument, or may, depending on the underlying instrument, “cash settle”. With the introduction of Financial Futures, Investment Banks, Banks, Insurance Companies and the like have been better able to manage their day-to-day business risk, in turn enabling them to offer a more competitive and “cheaper” priced financial product to their customers.

The present day Futures Contract has been one of the best financial tools ever created, although it has necessarily excluded those businesses whose very assets are by nature non-fungible. Today there is not a Futures Contract to accommodate a business with key assets that are not fungible. The present day Futures Contract requires that a property be standardized and interchangeable, like Oil, Wheat, Currency, Bonds, Pork Bellies, etc., wherein one property can be replaced by another property in satisfaction of an obligation. The Futures Contract, unlike the BLC, values the actual price of the underlying commodity or security, with the contract representing the wholesale price for delivered goods on a set future date at a designated Exchange location. While the Futures Contract meets the needs of businesses with properties that are fungible, it is incapable of providing a market mechanism with which to trade forward contracts for non-fungible property rights.

For instance, New York or Chicago commercial office space cannot be delivered to a designated delivery point or warehouse in satisfaction of a Futures Contract obligation. Moreover, the pricing of a Futures Contract shadows the changing market value of the underlying commodity, whereas each particular office lease space is unique, thus varying in price, depending upon a multitude of factors: precise location, condition of the property, age, design, amenities, etc., making it impossible to “commoditize” and thus trade office lease space like Oil, Wheat or Bonds using a standardized uniform Futures Contract. In short, the present “Art” (the Futures Contract) is not designed nor is it capable of being used to trade non-fungible property rights as standardized Exchange-traded commodity contracts.

With the invention of the BLC, industries whose assets are non-fungible will for the first time be able to use the Futures market as a tool to manage and reduce their market risk.

For example, office buildings are grouped into three classifications: Class A, for the newest and best equipped; Class B, for older properties in less choice locations; and Class C, for the least desirable location. (Among each of the classifications, lease rates can vary appreciably, depending upon style, location and prestige of the building, etc.) The overall lease rate for each of these classifications is set by the market, reflecting supply and demand. If the average lease office space rate declines for Class A space, then B and Cs' rates will decline as well in “sympathy”. On the other hand, if Class A space rates increase in value, then B and C will almost invariably mirror the increase.

Today, because there is not a Futures Contract available to hedge this risk, building owners, financial institutions and the like are defenseless against the inevitable occasional downturns in the market for office space. Assume for a moment that Class A is leasing on average for $45 per square foot in New York City. However, the market outlook is that vacancy rates are increasing, 10 to 12 million square feet of new office space is due to come on the market, and companies are having to lay off employees because of an economic downturn in the economy throwing additional sublet space on the market. Using a BLC, a building owner could hedge his future lease revenue by selling a Futures Contract in the forward market. In the event New York City leases for Class A space (as defined below) were then to fall, the BLC would decrease in price and thus (since the owner was “short”) this would partially or fully offset the building owner's loss from the decline in future lease rates. Another example would be a Developer who is seeking financing for the construction of a 60-story 2 million square foot office building in downtown Manhattan. The building is projected to be completed within 5 years. However, to justify the investment and in turn more readily assure the cash flow to service the debt, the Developer is required to assure minimum gross revenue of $35 per square foot. By using a BLC, the Developer could sell forward (short sale) real estate contracts on the exchange, and then pledge the contracts as additional collateral. In the event the real estate office leasing market were to fall, the futures contracts would then increase in value offsetting any decrease in the building lease revenue. Thus, the Developer would be able to protect his projected income, as well as the Bank's Mortgage.

Another example of non-fungible property rights is found with a Professional Sports Franchise, the primary assets which are the Player Contracts for individual athletes (players). Because of the Futures Contract limitations, the Franchise would be incapable of being able to use a Futures Contract to “hedge” its financial exposure arising from these expensive contracts on which basically the Franchise depends. For instance, Alex Rodriguez's 10-year, $250-million contract with the Texas Rangers, Donovan McNabb's 10-year, $120-million contract with the Philadelphia Eagles or Grant Hill's 7-year, $93-million contract with the Orlando Magic are all contracts (assets) that are highly individualized, unique, non-deliverable and varying in price depending upon the individual player's perceived capabilities.

Futures Contracts are a type of derivative security because the value of the contract is derived from the value of the underlying instrument. As noted previously, the Contract is standardized, whereby the following “Five” general terms are stipulated:
1. The identity of the underlying Commodity or Financial Instrument,
2. The Futures Contract size,
3. The Futures maturity date, also called the expiration date,
4. The delivery or settlement procedure,
5. The Futures Price.
First: A Futures Contract requires that the underlying Commodity or Financial Instrument clearly be identified.
Second: The size of the Contract must be specified. For example, the standard Contract size for Crude Oil Futures is 1,000 barrels (42-gallon per barrel). For U.S. Treasury Notes and Bond Futures, the standard Contract size is $100,000 in par value Notes or Bonds, respectively.
Third: The Contract term must be stated, i.e. the maturity date. The Contract maturity date is the date on which the seller is obligated to make delivery and the buyer is obligated to make payment.
Fourth: The delivery process must be specified. For commodity Futures, delivery normally entails sending a warehouse receipt for the appropriate quantity of the underlying commodity. After delivery, the buyer pays warehouse storage costs until the commodity is sold or otherwise disposed of. For Financial Futures, delivery is often accomplished by a transfer of registered ownership, or the contract cash settles, meaning that the buyer and seller simply settle up in cash, with no actual delivery to take place.
Fifth: The Futures price must be mutually agreed upon by the buyer and the seller. The Futures price is obviously important, since it is the price that the buyer will pay the seller for delivery at Contract maturity.

One of the core aspects of applicant's invention is a change in the above mentioned fifth vital characteristic of the standardized traditional Commodity Futures Contract: the method of establishing the Opening and Closing Prices of the BLC.

The BLC must have an Opening Price on the Exchange. This is supplied for the initial offering of Contracts through use of an algorithm designed for the particular BLC market.

Again, as to settlement, since there cannot be delivery of the “subject matter” of the BLC, all settlements for Contracts still open at maturity must be for cash. And there must thus be some method to set the maturity price. The BLC does this by use of this same algorithm.

Thus a BLC on star Baseball Player Alex Rodriguez, shortstop for the Texas Rangers, (who has recently been traded to the New York Yankees) would obligate the buyer to pay or collect the amount determined not by transactions on a Public Exchange, but by netting the price at which the buyer bought his contract against the maturity price determined by the agreed algorithm, which reflects Rodriguez's recent batting, fielding, base-stealing, etc. over the course of the Contract's duration until its maturity. Conversely, if one had sold a Contract on Mr. Rodriguez (at for example $35) and held such Contracts to maturity (at which the algorithm determined the closing price to be $30), the seller would collect a $5 profit on the short sale.

Similarly, a BLC on 5,000 square feet of Class A Mid-Town New York City office space has its settlement price at maturity determined not by transactions on a Public Exchange but by an agreed algorithm reflecting actual leasing transactions in such space reported to an agreed agency to collect such statistics.

Of course, as to either such BLC, the buyer or seller may alternatively settle such BLC by making an offsetting sale at the BLC market price then available at any time prior to maturity.

Recall that there have been two distinct eras in the history of the CFC: first, we had CFCs for grains, metals and the like where the CFCs called for delivery of fungible commodities at maturity. Second: in the 1970s we had new financial derivative CFCs on currencies, stock and commodity indices—but still where the underlying referent property (currencies, stocks, CFCs) were themselves fully fungible. The invention of BLCs moves us into a third era; BLCs, (much like CFCs) in respect of non-fungible property through the mechanism of trading not the referent property but only the perceived changes in the market value of the referent or underlying non-fungible property.

The BLC, it is plain, is not just a new CFC, Financial Futures Contract or a modification of such an old contract, but a totally new concept of “commoditizing” heretofore “un-commoditizable” assets. Thus business and investors have a new risk management technique for assets not previously subject to such risk management. Moreover, the BLC is able to aid economists and analysts of a particular market by providing new and useful data for that market. This helps businesses, investors and speculators make actual business decisions.

With the invention of the BLC industries whose assets are non-fungible will for the first time be able to use the Futures market as a tool to manage and reduce their market risk.

### DETAILED DESCRIPTION OF THE INVENTION

The BLC utilizes much of the settled procedures applicable to CFCs on commodities futures exchanges, utilizing standardized terms and conditions applicable to CFCs generally, but because it prices and trades solely perceived changes in the value of the referent non-fungible property rather than the referent fungible property itself, two new elements are introduced:

1. Establishing the “Base Line”:

The BLC opening contract price and the closing or final settlement price are not determined by or derived from open transactions on a public stock or commodities exchange but, rather, are derived from an algorithm appropriate to and exclusively for the particular BLC being traded. By way of illustration, an embodiment of the present invention relating to Major League baseball players (titled the “Sports Player Contract”, or SPC) is set out in Schedule A. The “Base Line” opening price of $14,803 for Alex Rodriguez for his 2003 BLC is determined by his batting, fielding, runs scored and other relevant statistics for his 2002 season. These statistics (as presented by an agreed agency) are set out valuing each statistic (using a value point system specific to the SPC algorithm, see Schedule B), which in turn determines a “raw score” multiplied by a dollar value. The particular algorithm then in force would necessarily be a part of the BLC then being traded. But such algorithm could be refined as experience dictated for BLCs thereafter opening in the future.

The contract size for the SPC will be, as noted, total statistical points “raw score” divided by 1,000, being the U.S. dollar-per contract value. Again, the size of the contract may be varied in the future to respond to the needs of the market. Indeed, it is possible that several differently sized contracts could be offered. The opening trade will be at the BLC opening price determined by the algorithm or by auction. Trades thereafter will be determined by supply and demand based upon the market participants' expectations of the player's statistical output for the season.

2. Settlement for Open Contracts at Expiration:

The final trading day for the SPC contract will be the first Monday after the last playing day of the regular season. For players taking part in the post season, contracts shall expire the first business day after the last day of post-season play. In the event a settlement date is a holiday or weekend, the contract will be settled the next business day thereafter.

For contracts not closed out by 4 p.m. prevailing New York City time on the last trading day, the settlement price shall be established from the player's statistics for the season just completed using the algorithm for such contract in the same fashion as the opening price was determined (but in that case, of course, from statistics for the year prior).

In the event the settlement price so determined is greater than the price at which the buyer had bought said contract, then the seller shall pay the appropriate differential to the buyer in cash. If, however, the settlement price is lower, then the buyer shall make the differential payment to the seller.

Other contracts are easily envisioned. For instance, derivative BLCs for entire teams, permitting one to “sell short” the Yankees or to “buy” the Oakland Athletics, depending on one's perceptions of projected overall player statistics for such teams. Index contracts for individual positions (i.e. pitchers, catchers, shortstops, etc.) could be offered as well. Market participants could buy or sell the Index taking a position in the broader market or alternatively use the Index to hedge positions against existing player contracts.

In the event a player is removed from the team's roster (for death or otherwise) the SPC contract on him would close on the day prior to his death or such removal from the roster. Thus, any trades made thereafter would be canceled. Settlement would be two business days after such death or removal.

Comparable algorithms can be established similarly for professional players in other sports, e.g., Football, Basketball, Hockey, Soccer, etc.

Another embodiment of the invention relates to “Class A” office space in selected cities of the world. This contract is here referred to as a Real Estate Contract (or “REC”). Just as with the SPC, it will trade on a commodities futures exchange, utilizing standardized terms and conditions applicable to CFCs generally. Again, the “Base Line” for a particular REC cannot be set by the market, but is derived from an algorithm, the terms of which are set out in Schedule C for “Class A Midtown New York City” office space. Obviously, similar algorithms can be established for other important cities, e.g. London, Paris, Tokyo, Hong Kong, Houston, Atlanta, Los Angeles, etc., responding to the perceived needs of the market. Where a particular city has distinct separate office space markets (e.g., New York with more expensive “Midtown” space vs. lower-priced “Downtown” space) separate RECs can be offered. However, it may be found that space for these two markets tends to move sympathetically: that is, if “Midtown” space is moving up, so too will “Downtown” space. If so, those interested in hedging or speculating in “Downtown” space will be able to do so utilizing the “Midtown” REC.

Fashioning and offering particular RECs will depend on the needs of the market generally. Obviously, the definitions of “Class A” space and the geographic limits (including a list of eligible “Class A” buildings) of a particular REC (e.g., does a particular building fall within the definition of “Midtown”) must be set out with particularity and will be part of the terms of the particular REC. But in time as experience dictates such definitions could be refined for RECs later offered.

Other BLC contracts for real estate are easily envisioned. For instance, these could be contracts for square footage for residential properties (single-family homes) throughout the U.S. (e.g., Kansas City, Dallas, Boston, Los Angeles, etc.), so that price movements and variances in price form one city or region of the country to another) could be traded. Also, contracts for apartment rental leases across the U.S., which typically move up and down inversely to home mortgage interest rates, and vary with the region of the country, employment rates, and local supply of apartments, among other things, could be offered and traded as well. Additionally, BLCs for warehouse space could be offered and traded.

SCHEDULE A
ALGORITHM (ALEX RODRIGUEZ, SHORTSTOP)
2002 SEASON

| | Points | Actual (2002) | Total | |
|---|---|---|---|---|
| Category | Per Stat | Playing Statistics | Points | Dollar Value |
| ATB | 2000 | 624 | 1248000 | $1248 |
| R | 20000 | 125 | 2500000 | 2500 |
| H | 30000 | 187 | 5610000 | 5610 |
| HR | 60000 | 57 | 3420000 | 3420 |
| RBI | 40000 | 142 | 5680000 | 5680 |
| BB | 25000 | 87 | 2175000 | 2175 |
| SB | 15000 | 9 | 135000 | 135 |
| SO | −25000 | 122 | −3050000 | −3050 |
| CS | −15000 | 3 | −45000 | −45 |
| RLSP | −30000 | 15 | −450000 | −450 |
| GIDP | −30000 | 2 | −60000 | −60 |
| E | −25000 | 5 | −12500 | −125 |
| RSE | −40000 | 0 | 0 | 0 |
| O | −5000 | 437 | −2185000 | −2185 |
| OA | 20000 | 0 | 0 | 0 |
| FSAC | −10000 | 5 | −50000 | −50 |
| *RCS | 25000 | 0 | 0 | 0 |
| *PB | −10000 | 0 | 0 | 0 |
| *SSA | −10000 | 0 | 0 | 0 |
| *CPO | 20000 | 0 | 0 | 0 |
| *RSPB | −25000 | 0 | 0 | 0 |
| Total | | | 14803000 | $14,803 |

SCHEDULE B
Points Per Stat (PPS)

| | | |
|---|---|---|
| Stats Abbreviation | Meaning | Points (+ or −) |

Infielders, Outfielders

| | | |
|---|---|---|
| ATB | No. of Times Up to Bat | +2,000 |
| R | Runs | +20,000 |
| H | Hits | +30,000 |
| HR | Home Runs | +60,000 |
| RBI | Runs Batted In | +40,000 |
| BB | Walks | +25,000 |
| SB | Stolen Bases | +15,000 |
| OA | Outfield Assist | +20,000 |
| SO | Strike Outs | −25,000 |
| CS | Caught Stealing Base | −15,000 |
| RSE | Runs Scored on Error | −40,000 |
| RLSP | Runners Left Scoring Position | −30,000 |
| GIDP | Ground Into Double Play | −30,000 |
| E | Error | −25,000 |
| O | Outs | −5,000 |
| FSAC | Failed Sacrifice | −10,000 |
| *RCS | Runners Caught Stealing | +25,000 |
| *PB | Pass Ball | −10,000 |
| *SSA | Successful Steal Against | −10,000 |
| *CPO | Catcher Pick Offs | +20,000 |
| *RSCRDPB | Runs Second on Pass Ball | −25,000 |

Pitchers

| | | |
|---|---|---|
| RPO | Runners Picked Off | +25,000 |
| W | Wins | +100,000 |
| IP | Innings Pitched | +5,000 |
| SV | Saves | +50,000 |
| SO | Strike Outs | +25,000 |
| CG | Complete Games | +50,000 |
| SHOW | Shut Out Win | +50,000 |
| QS | 7-Innings or More with Lead | +25,000 |
| IRS | Inherited Runners Strd. | +15,000 |
| IRSCRD | Inherited Runners Scored | −25,000 |
| ER | Earned Runs | −15,000 |
| H | Hits | −10,000 |
| BB | Walks | −10,000 |
| L | Losses | −25,000 |
| HRA | Home Runs Allowed | −25,000 |
| BLWSV | Blown Save | −75,000 |
| WP | Wild Pitch | −10,000 |
| E | Error | −15,000 |
| HB | Hit Batter | −15,000 |
| RSCRWP | Runs Scored on Wild Pitch | −25,000 |

End of Season Bonus Points

| | | |
|---|---|---|
| IP 1-24 | Innings Pitched | +2,000 |
| IP 25-48 | Innings Pitched | +3,000 |
| IP 49-72 | Innings Pitched | +5,000 |
| IP 73-120 | Innings Pitched | +7,500 |
| IP 121-168 | Innings Pitched | +10,000 |
| IP 169-192 | Innings Pitched | +15,000 |
| IP 193-216 | Innings Pitched | +25,000 |
| IP 217-240 | Innings Pitched | +50,000 |
| IP 241-264 | Innings Pitched | +75,000 |
| IP 265-Over | Innings Pitched | +100,000 |

End of Season Bonus Points For Relief Pitchers

| | | |
|---|---|---|
| IP 1-10 | Innings Pitched | +3,000 |
| IP 11-20 | Innings Pitched | +5,000 |
| IP 21-30 | Innings Pitched | +10,000 |
| IP 31-40 | Innings Pitched | +15,000 |
| IP 41-50 | Innings Pitched | +20,000 |
| IP 51-60 | Innings Pitched | +50,000 |
| IP 61-70 | Innings Pitched | +75,000 |
| IP 71-80 | Innings Pitched | +100,000 |
| IP 81-Over | Innings Pitched | +150,000 |

(*For Catchers Only)

### REC Schedule C

It is currently anticipated that the REC for “Class A” Midtown New York City office space will be a 3-month contract. REC contracts will be offered 10-years forward. As the prompt contract expires, a new contract shall be opened wherein 10-year (or 40-REC) contracts will at all times be displayed/offered over the exchange.

The REC's algorithm will be used to establish the prompt contract's initial opening price. After the first full 2-minutes of trading, the contract will be closed and then reopened after the last forward contract is opened. Contracts will be opened in rotation (i.e., first quarter contract, second quarter contract, etc.) until all 40 contracts are opened. After the first contract concludes its initial opening procedure, the following contracts shall be opened one at a time by open auction, which in turn will determine that specific contract's opening price. Once a contract is opened and trades for a full 2 minutes, the contract will then be closed and the next contract in rotation will be opened. After each of the REC contracts have concluded their opening procedures, all 40 contracts shall be reopened simultaneously, upon which trading of the contracts shall resume. As stated above, once the prompt contract expires, one additional contract (the last listed contract) will be opened (opening price determined by open auction), so that at all times 40 contracts shall be offered.

The algorithm for the “Class A” Midtown New York City REC shall be the weighted average annual square foot leasing rate for all leasing transactions for the referent “Class A” Midtown space as defined for the calendar quarter year prior to the determination of the “Base Line” opening price or the final settlement price as the case may be, as reported by an agreed agency to gather and disseminate such data. Said agency shall apply industry-agreed standards to take into account landlord concessions, “build-out” allowances and the like and to determine the “Class” of a particular building.

Each REC contract is for 1,000 square feet. The per-square foot figure (reported by the agreed agency) shall be multiplied by 1,000, the product being the U.S. dollar per-contract price. Again, like almost all BLCs, the REC's initial opening price shall be established by an appropriate algorithm. Prices thereafter shall be determined by supply and demand based upon market participants' expectations as to the particular office lease market. Contracts that have not closed out by 4 p.m. prevailing New York City time on the last trading day of the contract term shall price settle against the predetermined algorithm. The algorithm's settlement price will reflect the actual leasing transactions for the months listed in the REC expiring contract, (i.e., January-March, April-June, July-September, October-December). The REC's initial opening price shall be determined from the weighted average for all transactions meeting the contract definition for the preceding calendar quarter as reported by the agreed agency that collects and disseminates such data.

The weighting will be on the basis of the size (number of square feet involved) of a particular transaction effected in such calendar quarter. By way of example, a lease for 1-million square feet will be treated as having 10 times the impact on the final weighted average than one for 100,000 square feet.

A greatly over-simplified example of how the algorithm works can here be set out. Assume for the preceding calendar quarter there were just four transactions. (In actual fact, the market reports a vast number of completed transactions per quarter.) In transaction A, 1-million square feet was leased at an adjusted (for landlord concession, build-out, etc.) at $43 per foot (per year). In B, 100,000 square feet was leased for $47. In C, 250,000 square feet was leased for $45.50. And in D, 420,000 square feet was leased for $47.10. Total square footage leased: 1,770,000. For each transaction, the algorithm establishes a fraction of which the numerator is the number of square feet for that transaction and the denominator is the total square footage leased for the quarter. This fraction is applied to the actual adjusted price for the particular transaction. And this product is then added to all the other products similarly established, the total then being the final weighted price for the calendar quarter and the opening Base Line price for the contract.

The following is a table using the data of the foregoing hypothetical illustrative of the working of the algorithm. It will be recalled that all prices will be adjusted for landlord concessions, build-out allowances and the like in accordance with settled industry practices and to take into account the length of the particular lease.

REC ALGORITHM

| | No. of | Adjusted | | |
|---|---|---|---|---|
| TRANSACTION | Square Feet | Price/Sq. | Fraction | Product |
| A | 1,000,000 | $43.00 | 1000 | $24.2938 |
| | | | \overline{1770} | |
| B | 100,000 | 47.00 | 100 | 2.6554 |
| | | | \overline{1770} | |
| C | 250,000 | 45.50 | 250 | 6.4266 |
| | | | \overline{1770} | |
| D | 420,000 | 47.10 | 420 | 11.1763 |
| | | | \overline{1770} | |
| Total | 1,770,000 | | | $44.5521 |

Thus, the opening REC price will be $44.55.

The calculation of the opening Base Line price need only be made once: when the first REC contract is offered. Thereafter, prices are determined by the market participants' expectations of the office lease market (in sum supply and demand).

The only other use for the algorithm (after establishing the REC's initial opening) is to determine the cash settlement price for the few contracts not otherwise closed out prior to the contract's expiration date, (i.e., the end of each contract calendar quarter). The settlement price will apply the algorithm to all of the reported transactions for the calendar quarter just expiring.

It has yet to be determined whether the REC's settlement price (determined by the algorithm) should be published periodically (e.g., at the end of each calendar month) or on a daily running basis. The needs of the market will decide this aspect.

As an example of how the algorithm works in establishing the settlement price, assume these purposely over simplified facts:

| | Number of | Adjusted | | |
|---|---|---|---|---|
| Transactions | Square Feet | Price/Square Feet | Fraction | Product |
| E | 500,000 | $43.37 | 500 | 11.333 |
| | | | \overline{2090} | |
| F | 100,000 | $47.15 | 100 | 2.256 |
| | | | \overline{2090} | |
| G | 820,000 | $48.12 | 820 | 18.880 |
| | | | \overline{2090} | |
| H | 670,000 | $48.72 | 670 | 15.618 |
| | | | \overline{2090} | |
| Total | 2,090,000 | | | 48.087 |

Thus, the REC settlement price is $48.09.

As can be seen, the market continued to be strong, rising more or less consistently over the calendar quarter. Assume a landlord or a speculator has earlier bought one REC contract for $46.10 and had decided not to make an offsetting sale prior to expiration. At settlement, the party who had sold that REC would owe the buyer the difference between the settlement price of $48.09 and $46.10, or $1.99,×1,000 for a total of $1,990. (recall that each REC contract is for 1,000 square feet)

### Description of the Preferred Embodiment

The Base Line Contract is intended to be offered and traded on an existing (or newly formed) zed public Futures Exchange.

1. A method of doing business enabling the trading of Futures Contracts for non-fungible properties, which comprises a traditional commodities Futures Contract, but wherein an algorithm determines the opening price of the property traded.

2. A method of doing business enabling the trading of Futures Contracts for non-fungible properties, which comprise a traditional commodities futures contract, but wherein the physical delivery requirement is omitted.

3. A method as claimed in claim 1, wherein said algorithm determines the cash settlement price for contracts that are not closed out at expiration.

4. A method of doing business enabling the trading of Futures Contracts for changes in value of non-fungible properties, which comprise a traditional Commodities Futures Contract wherein the opening price is determined by auction and the settlement price for each contract not closed out at expiration by auction is determined by an algorithm.

5. A method of doing business as claimed in claim 1 wherein the change in value of the underlying non-fungible property is traded.

6. A method of doing business as claimed in claim 3 wherein the change in value of the underlying non-fungible property is traded.

7. A method of doing business as claimed in claim 4 wherein the change in value of the underlying non-fungible property is traded.

8. A method of doing business enabling the trading of Futures Contracts for non-fungible properties which comprises a traditional commodities Futures Contract wherein the delivery is for cash settlement only, the price of which is determined by an algorithm.

9. A method of doing business as claimed in claim 7 wherein the opening and delivery price reflects the change in value of said non-fungible property through the use of said algorithm establishing a base line price from which price movements are calculated.

10. A method of doing business as claimed in claim 7 wherein the monetary value of a non-fungible property's change in value can either be gained by selling short or by going long.

11. A method of doing business as claimed in claim 7 wherein the monetary value of a non-fungible property can be hedged.

12. A method as claimed in claim 5 wherein said change in value is determined by an algorithm for contracts not otherwise settled at expiration of the contract.

13. A method as claimed in claim 1 wherein said non-fungible property is a professional Baseball Player.

14. A method as claimed in claim 2 wherein said non-fungible property is a professional Baseball Player.

15. A method as claimed in claim 3 wherein said non-fungible property is a professional Baseball Player.

16. A method as claimed in claim 4 wherein said non-fungible property is a professional Baseball Player.

17. A method as claimed in claim 5 wherein said non-fungible property is a professional Baseball Player.

18. A method as claimed in claim 1 wherein said non-fungible property is a professional Football Player.

19. A method as claimed in claim 2 wherein said non-fungible property is a professional Football Player.

20. A method as claimed in claim 3 wherein said non-fungible property is a professional Football Player.

21. A method as claimed in claim 4 wherein said non-fungible property is a professional Football Player.

22. A method as claimed in claim 5 wherein said non-fungible property is a professional Football Player.

23. A method as claimed in claim 1 wherein said non-fungible property is a professional Basketball Player.

24. A method as claimed in claim 2 wherein said non-fungible property is a professional Basketball Player.

25. A method as claimed in claim 3 wherein said non-fungible property is a professional Basketball Player.

26. A method as claimed in claim 4 wherein said non-fungible property is a professional Basketball Player.

27. A method as claimed in claim 5 wherein said non-fungible property is a professional Basketball Player.

28. A method as claimed in claim 1 wherein said non-fungible property is a professional Soccer Player.

29. A method as claimed in claim 2 wherein said non-fungible property is a professional Soccer Player.

30. A method as claimed in claim 3 wherein said non-fungible property is a professional Soccer Player.

31. A method as claimed in claim 4 wherein said non-fungible property is a professional Soccer Player.

32. A method as claimed in claim 5 wherein said non-fungible property is a professional Soccer Player.

33. A method as claimed in claim 1 wherein said non-fungible property is a professional Hockey Player.

34. A method as claimed in claim 2 wherein said non-fungible property is a professional Hockey Player.

35. A method as claimed in claim 3 wherein said non-fungible property is a professional Hockey Player.

36. A method as claimed in claim 4 wherein said non-fungible property is a professional Hockey Player.

37. A method as claimed in claim 5 wherein said non-fungible property is a professional Hockey Player.

38. A method as claimed in claim 1 wherein said non-fungible property is leaseable Office Space.

39. A method as claimed in claim 2 wherein said non-fungible property is leaseable Office Space.

40. A method as claimed in claim 3 wherein said non-fungible property is leaseable Office Space.

41. A method as claimed in claim 4 wherein said non-fungible property is leaseable Office Space.

42. A method as claimed in claim 5 wherein said non-fungible property is leaseable Office Space.

43. A method as claimed in claim 1 wherein said non-fungible property is Warehouse Space.

44. A method as claimed in claim 2 wherein said non-fungible property is Warehouse Space.

45. A method as claimed in claim 3 wherein said non-fungible property is Warehouse Space.

46. A method as claimed in claim 4 wherein said non-fungible property is Warehouse Space.

47. A method as claimed in claim 5 wherein said non-fungible property is Warehouse Space.

48. A method as claimed in claim 1 wherein said non-fungible property is a Single Family Home.

49. A method as claimed in claim 2 wherein said non-fungible property is a Single Family Home.

50. A method as claimed in claim 3 wherein said non-fungible property is a Single Family Home.

51. A method as claimed in claim 4 wherein said non-fungible property is a Single Family Home.

52. A method as claimed in claim 5 wherein said non-fungible property is a Single Family Home.
